(19) United States
(12) Patent Application Publication
(10) Pub. No.: US 2026/0222882 A1
(43) Pub. Date: Jul. 30, 2026

(54) UE-INITIATED BEAM REPORTING TRIGGER STATES

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US); Dalin Zhu, Allen, TX (US)

(21) Appl. No.: 19/455,693

(22) Filed: Jan. 21, 2026

Related U.S. Application Data
(60) Provisional application No. 63/751,644, filed on Jan. 30, 2025.
(60) Provisional application No. 63/782,489, filed on Apr. 2, 2025.
(60) Provisional application No. 63/868,856, filed on Aug. 22, 2025.
(60) Provisional application No. 63/903,563, filed on Oct. 22, 2025.

(51) Int. Cl. H04W 24/10

(52) U.S. Cl. CPC H04W 24/10

(57) ABSTRACT

A method of operating a UE includes receiving a UE initiated channel state information (CSI) reporting configuration, and performing a CSI measurement based on the UE initiated CSI reporting configuration. The method also includes determining, based on the CSI measurement, whether an event has been fulfilled, and in response to the event being fulfilled, determining whether to transmit at least one of a CSI report indication and an associated CSI report to a network (NW).

### CROSS-REFERENCE TO RELATED APPLICATION(S) AND CLAIM OF PRIORITY

This application claims priority under 35 U.S.C. § 119(e) to U.S. Provisional Patent Application No. 63/751,644 filed on Jan. 30, 2025, U.S. Provisional Patent Application No. 63/782,489 filed on Apr. 2, 2025, U.S. Provisional Patent Application No. 63/789,769 filed on Apr. 16, 2025, U.S. Provisional Patent Application No. 63/868,856 filed on Aug. 22, 2025, U.S. Provisional Patent Application No. 63/903,563 filed on Oct. 22, 2025. The above-identified provisional patent applications are hereby incorporated by reference in their entirety.

### TECHNICAL FIELD

This disclosure relates generally to wireless networks. More specifically, this disclosure relates to user equipment (UE)-initiated beam reporting trigger states.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for UE-initiated beam reporting trigger states.

In one embodiment, a method of operating a user equipment (UE) is provided. The method includes receiving a UE initiated channel state information (CSI) reporting configuration, and performing a CSI measurement based on the UE initiated CSI reporting configuration. The method also includes determining, based on the CSI measurement, whether an event has been fulfilled, and in response to the event being fulfilled, determining whether to transmit at least one of a CSI report indication and an associated CSI report to a network (NW).

In another embodiment, a method of operating a base station (BS) is provided. The method includes transmitting a UE initiated CSI reporting configuration. The method also includes, in response to a determination by a UE that an event has been fulfilled, receiving at least one of a CSI report indication and an associated CSI report from the UE.

In yet another embodiment, an electronic device is provided. The electronic device includes at least one processor including processing circuitry, and memory storing instructions. The instructions, when executed by the at least one processor individually or collectively, cause the electronic device to receive a UE initiated CSI reporting configuration, and perform a CSI measurement based on the UE initiated CSI reporting configuration. The instructions, when executed by the at least one processor individually or collectively, also cause the electronic device to determine, based on the CSI measurement, whether an event has been fulfilled, and in response to the event being fulfilled, determine whether to transmit at least one of a CSI report indication and an associated CSI report to a NW.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] 3GPP, TS 38.300 v18.4.0, 5G; NR; NR and NG-RAN Overall Description; Stage 2.
[2] 3GPP, TS 38.331 v18.4.0, 5G; NR; Radio Resource Control (RRC); Protocol specification
[3] 3GPP, TS 38.321 v18.4.0, NR; Medium Access Control (MAC) protocol specification.
[4] 3GPP, TS 38.304 v18.4.0, NR; User Equipment (UE) procedures in Idle mode and RRC Inactive state.
[5] 3GPP, TS 38.306 v18.4.0, NR; User Equipment (UE) radio access capabilities.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example UE procedure for UEI-BR according to embodiments of the present disclosure;

FIG. 5 illustrates an example NW procedure for UEI-BR according to embodiments of the present disclosure;

FIG. 6 illustrates an example MAC subheader with an LCID for UEI-BR Trigger State Subselection MAC CE according to embodiments of the present disclosure;

FIG. 7 illustrates another example MAC subheader with an LCID for UEI-BR Trigger State Subselection MAC CE according to embodiments of the present disclosure;

FIG. 8 illustrates example UEI-BR Trigger State Subselection MAC CE according to embodiments of the present disclosure;

FIG. 9 illustrates example Aperiodic CSI Trigger State Subselection MAC CE with U field according to embodiments of the present disclosure;

FIG. 10 illustrates example Aperiodic CSI Trigger State Subselection MAC CE according to embodiments of the present disclosure;

FIG. 11 illustrates an example UE procedure for cross-cell UEI-BR according to embodiments of the present disclosure;

FIG. 12 illustrates example method for UE-initiated beam reporting trigger states according to embodiments of the present disclosure; and

FIG. 13 illustrates another example method for UE-initiated beam reporting trigger states according to embodiments of the present disclosure.

### DETAILED DESCRIPTION

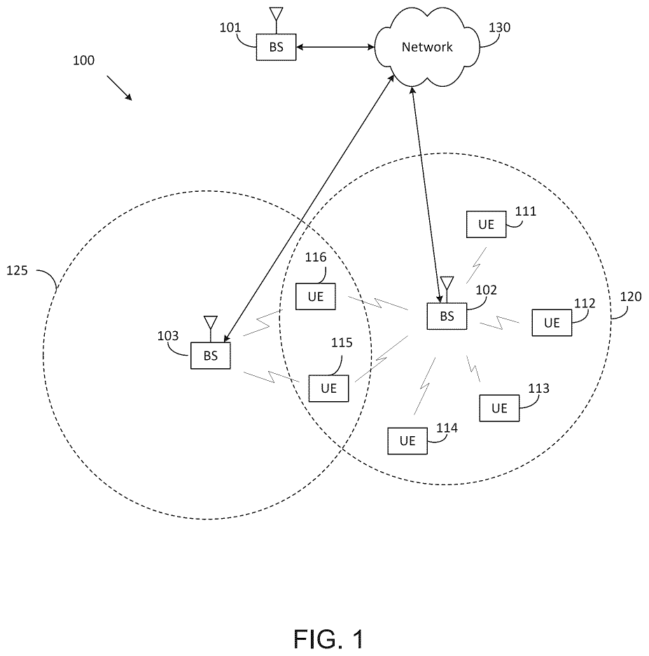

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE-initiated beam reporting trigger states. In certain embodiments, one or more of the gNBs 101-103 includes circuitry, programing, or a combination thereof, to support UE-initiated beam reporting trigger states in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

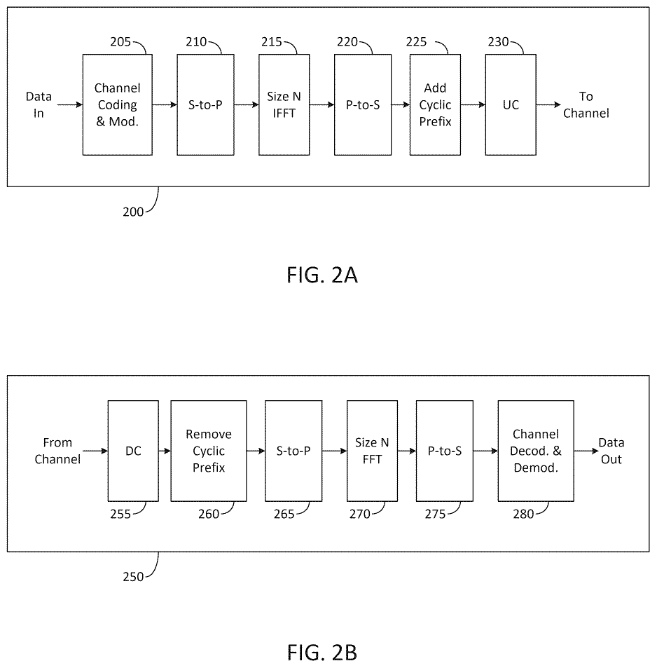

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support UE-initiated beam reporting trigger states as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

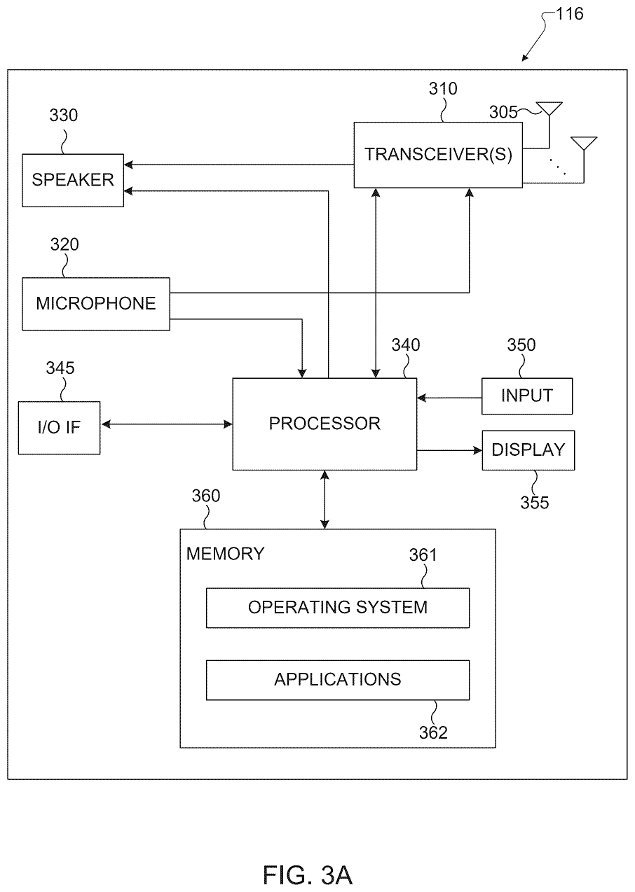

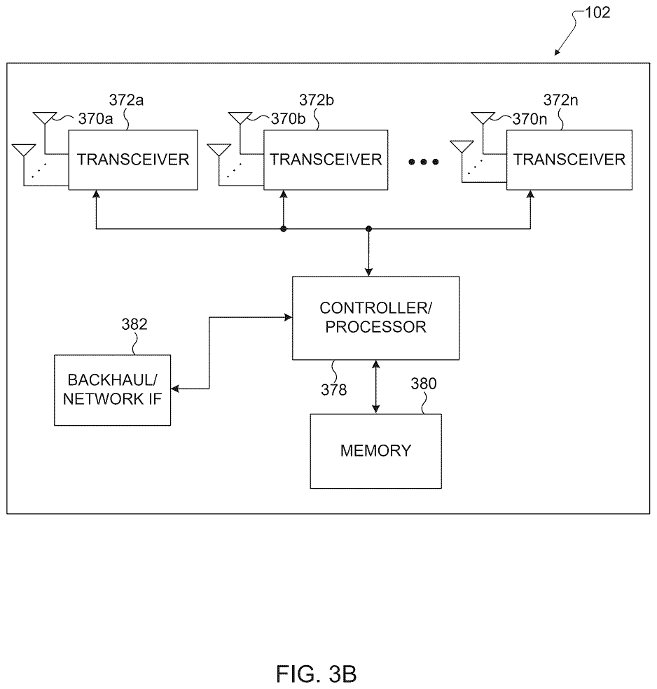

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE-initiated beam reporting trigger states as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support UE-initiated beam reporting trigger states as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

The Third-Generation Partnership Project (3GPP) has developed technical specifications and standards to define a fifth generation (5G) radio-access technology, known as 5G New Radio (NR). In a multi-beam system, beam management refers to the features to manage and control beams. In existing beam management procedures, the network may configure/activate frequent periodic or semi-persistent beam reporting (e.g., N best beams and corresponding L1-RSRPs) or trigger frequent aperiodic beam reporting to timely acquire the best/preferred beam for data/control transmissions. However, this results in large UL reporting overhead and control signaling overhead. However, if less frequent beam reporting is configured, the network may not always acquire the ‘best/preferred’ beam(s), as the beam reporting by the UE may be outdated, thus leading to performance degradation. Given that UE has better and more-timely knowledge of beam quality changes, a UE-initiated beam reporting procedure can lead to more timely beam reports with reduced reporting overhead. For example, under such a procedure, if the UE determines that current beam(s) quality becomes poor, the UE can trigger beam reporting (e.g., including information on CSI) without the network needing to configure or trigger frequent reporting.

In some embodiments, UE initiated beam reporting can be triggered by certain event(s) that are pre-configured or pre-defined. For example, upon the condition(s) of a certain event UE being fulfilled, a beam report can be triggered. In embodiments such as these, the UE can transmit the beam report (e.g., including information for CSI) in Uplink Control Information (UCI). In some embodiments, for UE initiated beam reporting, the UE first receives a configuration on UE initiated beam reporting from the BS, including information on events, and/or RS(s) to be measured, and/or report content, and/or resource allocated for reporting. Then, the UE starts to evaluate the events by measuring the indicated/configured RS(s). Upon the condition of a certain event being fulfilled, the UE initiates the report procedure and transmits the beam report as UCI to the BS.

In some embodiments, for a UE initiated beam report using a dynamic grant, the UE may first transmit a notification to the base station by including the notification (e.g., a one-bit flag) in UCI, and receive a dynamic grant indicated in downlink control information (DCI) for the UE initiated beam reporting, and finally transmit the report as UCI in the provided dynamic grant. In embodiments such as these, the detailed configuration and signalling to control the UE initiated beam reporting and the relevant UE behaviour should be specified. Various embodiments of the present disclosure provide mechanisms for configuration and signalling to control dynamic-grant-based UE initiated beam reporting by trigger states.

In some embodiments, for a UE initiated beam report procedure, in report mode-A, the UE first transmits a notification to the base station by including the notification (e.g., in a one-bit flag) in UCI, and receives a dynamic grant indicated in DCI for the UE initiated beam reporting, and finally transmits the report as UCI in the provided dynamic grant.

In some embodiments, in report mode-B, the UE first transmits a notification to the base station by including the notification (e.g., one-bit flag) in UCI and transmits the report as UCI in the configured UL grant provided in the UE initiated beam reporting configuration.

In some embodiments, the report notification on the PUCCH and the beam report on the physical uplink shared channel (PUSCH) can be transmitted on different serving cells in CA, and/or on different BWPs of one serving cell. Various embodiments of the present disclosure provide mechanisms for configuration and signalling to control cross-cell or cross-BWP UE initiated beam reporting and the related UE behaviour.

In the present disclosure, UE-initiated beam reporting (UEI-BR) and event-triggered beam reporting are used interchangeably to refer to the same operation(s). In the present disclosure the term “UE-initiated beam reporting” and “UE-initiated CSI reporting” are used interchangeably to refer to UE-initiated reporting of CSI or information associated with beams transmitted from or to BS.

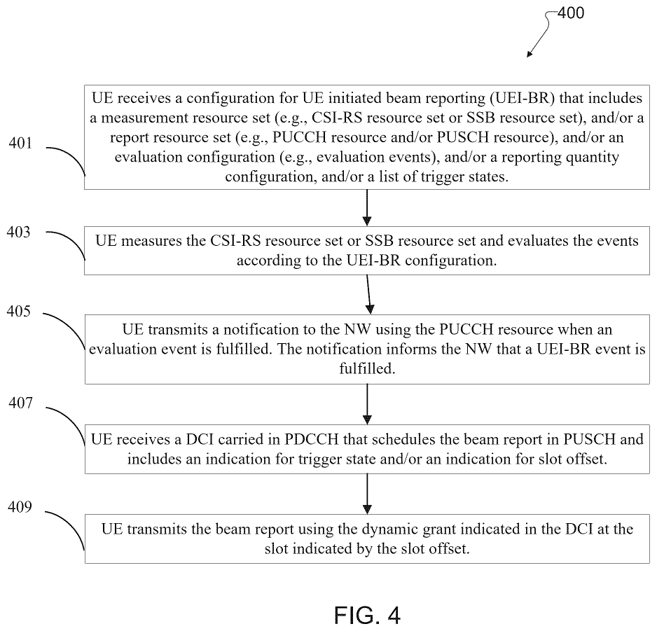

FIG. 4 illustrates an example UE procedure for UEI-BR 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a UE procedure for UEI-BR could be used without departing from the scope of this disclosure.

In the example of FIG. 4, the procedure 400 begins at operation 401. At operation 401, a UE (such as UE 116 of FIG. 1) receives a configuration for UEI-BR (e.g., in UE dedicated RRC signalling). The UEI-BR configuration can include a measurement resource set (e.g., a CSI-RS resource set or an SSB resource set), and/or a report resource set (e.g., a PUCCH resource and/or a PUSCH resource), and/or an evaluation configuration (e.g., evaluation events), and/or a reporting quantity configuration, and/or a list of trigger states. Each trigger state can indicate a list of slot offsets. Each slot offset refers to a time gap between the slot that DCI schedules the UE initiated beam reporting and the slot that the UE transmits the beam report.

At operation 403, the UE measures the CSI-RS resource set or SSB resource set and evaluates the events according to the UEI-BR configuration. At operation 405, the UE transmits a notification to the NW using the PUCCH resource when an evaluation event is fulfilled. The notification informs the NW that a UEI-BR event is fulfilled.

At operation 407, the UE receives a DCI carried in a PDCCH that schedules the beam report in a PUSCH. The DCI indicates a dynamic grant for the beam report transmission. The DCI includes an indication for trigger state and/or an indication for slot offset. For example, a first field in the DCI indicates a trigger state for UEI-BR. The number of bits of the first DCI field, denoted L, can be defined as a fixed integer number, or configured by an RRC parameter with an integer value, e.g., a value from {0, 1, 2, 3, 4, 5, 6}. A second field in the DCI indicates a slot offset (e.g., value 0 indicates the first slot offset in the slot offset list of the indicated trigger state, value 1 indicates the second slot offset in the slot offset list of the indicated trigger state, and etc.).

At operation 409, the UE transmits the beam report using the dynamic grant indicated in the DCI at the slot indicated by the slot offset. The report content includes an indication of the measured resource/beam (e.g., an index of a CSI-RS resource/beam or SSB resource/beam) that fulfils an evaluation event and/or the report quantity of the resource/beam (e.g., a measured RSRP). The report can include measurement result(s) of other measured resource(s)/beam(s) that are configured in the measurement resource set(s) for UEI-BR regardless of whether the measured resource/beam fulfils an evaluation event or not. For example, the report can include the index(es) and/or the measured RSRP values of up to N measured resource(s)/beams(s), where N is configured by a parameter in the UEI-BR configuration.

Although FIG. 4 illustrates one example UE procedure for UEI-BR 400, various changes may be made to FIG. 4. For example, while shown as a series of operations, various operations in FIG. 4 could overlap, occur in parallel, occur in a different order, occur any number of times, be omitted, or replaced by other operations.

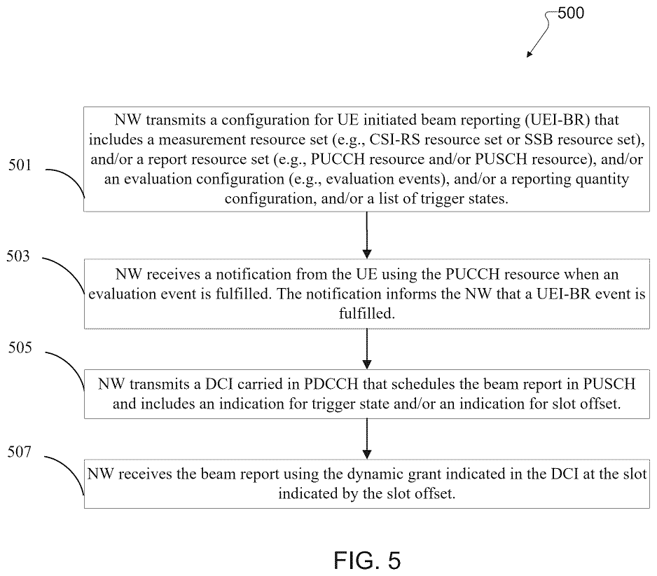

FIG. 5 illustrates an example NW procedure for UEI-BR 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a UE procedure for UEI-BR could be used without departing from the scope of this disclosure.

In the example of FIG. 5, the procedure 500 begins at operation 501. At operation 501, The network (for example, via gNB 102 of FIG. 1) transmits a configuration for UEI-BR (e.g., in UE dedicated RRC signalling). The UEI-BR configuration can include a measurement resource set (e.g., a CSI-RS resource set or an SSB resource set), and/or a report resource set (e.g., a PUCCH resource and/or a PUSCH resource), and/or an evaluation configuration (e.g., evaluation events), and/or a reporting quantity configuration, and/or a list of trigger states. Each trigger state can indicate a list of slot offsets. Each slot offset refers to a time gap between the slot that DCI schedules the UE initiated beam reporting and the slot that the UE transmits the beam report.

At operation 503, the NW receives a notification from the UE using the PUCCH resource when an evaluation event is fulfilled. The notification informs the NW that a UEI-BR event is fulfilled.

At operation 505, the NW transmits a DCI carried in a PDCCH that schedules the beam report in a PUSCH. The DCI indicates a dynamic grant for the beam report transmission. The DCI includes an indication for trigger state and/or an indication for slot offset. For example, a first field in the DCI indicates a trigger state for UEI-BR. The number of bits of the first DCI field, denoted L, can be defined as a fixed integer number, or configured by an RRC parameter with an integer value, e.g., a value from {0, 1, 2, 3, 4, 5, 6}. A second field in the DCI indicates a slot offset (e.g., value 0 indicates the first slot offset in the slot offset list of the indicated trigger state, value 1 indicates the second slot offset in the slot offset list of the indicated trigger state, and etc.).

At operation 507, the NW receives the beam report using the dynamic grant indicated in the DCI at the slot indicated by the slot offset. The report content includes an indication of the measured resource/beam (e.g., an index of a CSI-RS resource/beam or SSB resource/beam) that fulfils an evaluation event and/or the report quantity of the resource/beam (e.g., a measured RSRP). The report can include measurement result(s) of other measured resource(s)/beam(s) that are configured in the measurement resource set(s) for UEI-BR regardless of whether the measured resource/beam fulfils an evaluation event or not. For example, the report can include the index(es) and/or the measured RSRP values of up to N measured resource(s)/beams(s), where N is configured by a parameter in the UEI-BR configuration.

Although FIG. 5 illustrates one example UE procedure for UEI-BR 500, various changes may be made to FIG. 5. For example, while shown as a series of operations, various operations in FIG. 5 could overlap, occur in parallel, occur in a different order, occur any number of times, be omitted, or replaced by other operations.

In some embodiments, a list of trigger states can be specified dedicatedly for UEI-BR. In some embodiments, for RRC signalling, the list of UEI-BR trigger states is included in the CSI measurement configuration (e.g., in an IE CSI-MeasConfig), and each trigger state include a list of slot offsets, as follows:

```
CSI-MeasConfig ::=  SEQUENCE {
  UEI-BR-TriggerStateList  SetupRelease {UEI-BR-TriggerStateList}
OPTIONAL, -- Need M
  }
UEI-BR-TriggerStateList ::=  SEQUENCE (SIZE (1..maxNrOfUEI-BR-Triggers)) OF UEI-BR-
TriggerState
UEI-BR-TriggerState ::=  SEQUENCE
  reportSlotOffsetList  SEQUENCE (SIZE (1..maxNrofUL-Allocations)) OF
INTEGER(0..32)
}
```

In some embodiments, a subset of the existing aperiodic CSI trigger states included in a CSI measurement configuration are assigned dedicatedly to be used as UEI-BR trigger states. In some embodiments, for RRC signalling, each of the trigger states contains a field of UEI-BR-AssociatedReportConfigInfo that points to a CSI report configuration identified by CSI-ReportConfigId, as shown below.

```
CSI-MeasConfig ::=  SEQUENCE {
  aperiodicTriggerStateList  SetupRelease { CSI-AperiodicTriggerStateList }
OPTIONAL, -- Need M
  }
CSI-AperiodicTriggerStateList ::=  SEQUENCE (SIZE (1..maxNrOfCSI-AperiodicTriggers))
OF CSI-Aperiodic TriggerState
CSI-AperiodicTriggerState ::=  SEQUENCE {
  associatedReportConfigInfoList  SEQUENCE
(SIZE(1..maxNrofReportConfigPerAperiodicTrigger)) OF CSI-AssociatedReportConfigInfo,
  . . . ,
  [[
ap-CSI-MultiplexingMode-r17  ENUMERATED {enabled}  OPTIONAL -- Need
R
  ]],
  [[
    ltm-AssociatedReportConfigInfo-r18 LTM-CSI-ReportConfigId-r18  OPTIONAL
-- Need R
  ]],
  [[
UEI-BR-AssociatedReportConfigInfo-r19 CSI-ReportConfigId  OPTIONAL -- Need R
  ]]
}
CSI-ReportConfig ::=  SEQUENCE {
  reportConfigId  CSI-ReportConfigId,
  carrier  ServCellIndex  OPTIONAL, -- Need S
      UEI-BR-resourcesForChannelMeasurement-r19 UEI-BR-ResourceConfig-r19,
      reportConfigType-r19  CHOICE {
        UEI-BR  SEQUENCE {
          reportSlotOffsetList SEQUENCE (SIZE (1..maxNrofUL-Allocations)) OF
INTEGER(0..32),
    EventType  CHOICE {
      Event1  SEQUENCE {
          . . .omitting fields. . .
      }
      Event2  SEQUENCE {
          . . .omitting fields. . .
      }
      Event7  SEQUENCE {
          . . .omitting fields. . .
      }
          },
          }
  }
    UEI-BR-resourcesForReport-r19  SEQUENCE {
      firstPUCCHResourceConfig-r19  UEI-BR-FirstPUCCHResource-r19
  }
    reportQuantity  CHOICE {
      none  NULL,
      cri-RI-PMI-CQI  NULL,
      cri-RI-i1  NULL,
      cri-RI-i1-CQI  SEQUENCE {
        pdsch-BundleSizeForCSI  ENUMERATED {n2, n4}  OPTIONAL --
Need S
      },
      cri-RI-CQI  NULL,
      cri-RSRP  NULL,
      ssb-Index-RSRP  NULL,
      cri-RI-LI-PMI-CQI  NULL
    }
. . .omitting fields. . .
}
```

In embodiments such as these, if UEI-BR-associatedReportConfigInfo indicating a report configuration for UEI-BR is included in an aperiodic CSI trigger state, the UE ignores the field associatedReportConfigInfoList which is used to indicate a report configuration for aperiodic CSI. The list of slot offsets can be included in the CSI report configuration indicated by the UEI-BR trigger state. The CSI report configuration for UEI-BR, as shown above, can also include a measurement resource set (e.g., CSI-RS resource set or SSB resource set), and/or a report resource set (e.g., PUCCH resource and/or PUSCH resource), and/or an evaluation configuration (e.g., evaluation events), and/or a reporting quantity configuration.

In this case, the report content includes an indication of the measured resource/beam (e.g., index of a CSI-RS resource/beam or SSB resource/beam) that fulfils an evaluation event and/or the report quantity of that resource/beam (e.g., measured RSRP). The report can include measurement result(s) of other measured resource(s)/beam(s) that is configured in the measurement resource set(s) for UEI-BR regardless the measured resource/beam fulfils an evaluation event or not. The report can include the index(es) and/or the measured RSRP values of up to N measured resource(s)/beams(s), where N is configured by a parameter in a UEI-BR configuration. In some embodiments, the UE can report measured resource(s)/beam(s) associated to the indicated trigger state only. Alternatively, in some embodiments, the UE can report any measured resource(s)/beam(s) configured for UEI-BR.

In some embodiments, a subset of the existing aperiodic trigger states is assigned dedicatedly to be used as UEI BM trigger state, and each trigger state points to a list of CSI report configurations, where each CSI report configuration include a list of slot offsets. In embodiments such as these, an explicit enabling indication is used to indicate an existing aperiodic CSI trigger state is dedicatedly used for UEI BM, as shown in the example below:

```
CSI-MeasConfig ::=  SEQUENCE {
  aperiodicTriggerStateList  SetupRelease { CSI-AperiodicTriggerStateList }
OPTIONAL, -- Need M
    }
CSI-AperiodicTriggerStateList ::= SEQUENCE (SIZE (1..maxNrOfCSI-AperiodicTriggers))
OF CSI-Aperiodic TriggerState
CSI-AperiodicTriggerState ::=  SEQUENCE {
  associatedReportConfigInfoList  SEQUENCE
(SIZE(1..maxNrofReportConfigPerAperiodicTrigger)) OF CSI-AssociatedReportConfigInfo,
  . . . ,
  [[
ap-CSI-MultiplexingMode-r17  ENUMERATED {enabled}  OPTIONAL -- Need
R
  ]],
  [[
    ltm-AssociatedReportConfigInfo-r18 LTM-CSI-ReportConfigId-r18  OPTIONAL
-- Need R
      ]]
  [[
  UEI-BM-DedicatedTriggerState-r19 ENUMERATED {enabled}  OPTIONAL --
Need R
  ]]
}
CSI-ReportConfig ::=  SEQUENCE {
reportConfigId  CSI-ReportConfigId,
carrier  ServCellIndex  OPTIONAL, -- Need S
resourcesForChannelMeasurement  CSI-ResourceConfigId,
csi-IM-ResourcesForInterference  CSI-ResourceConfigId  OPTIONAL, -- Need R
nzp-CSI-RS-ResourcesForInterference  CSI-ResourceConfigId  OPTIONAL, -- Need R
reportConfigType  CHOICE {
  periodic  SEQUENCE {
    reportSlotConfig  CSI-ReportPeriodicityAndOffset,
    pucch-CSI-ResourceList  SEQUENCE (SIZE (1..maxNrofBWPs)) OF PUCCH-CSI-
Resource
  },
  semiPersistentOnPUCCH  SEQUENCE {
    reportSlotConfig  CSI-ReportPeriodicityAndOffset,
    pucch-CSI-ResourceList  SEQUENCE (SIZE (1..maxNrofBWPs)) OF PUCCH-CSI-
Resource
  },
  semiPersistentOnPUSCH  SEQUENCE {
    reportSlotConfig  ENUMERATED {s15, s110, s120, s140, s180, sl160, s1320},
    reportSlotOffsetList  SEQUENCE (SIZE (1..maxNrofUL-Allocations)) OF
INTEGER(0..32),
    p0alpha  P0-PUSCH-AlphaSetId
  },
  aperiodic  SEQUENCE {
    reportSlotOffsetList  SEQUENCE (SIZE (1..maxNrofUL-Allocations)) OF
INTEGER(0..32)
  },
  UEI-BM SEQUENCE {
    reportSlotOffsetList SEQUENCE (SIZE (1..maxNrofUL-Allocations)) OF
INTEGER(0..32)
    . . .omitting fields. . .
  }
      },
      . . .
```

Alternatively, in some embodiments, an existing aperiodic CSI trigger state is dedicatedly used for UEI BM by an implicit indication that all CSI report configurations associated to the trigger state are configured with report type of UEI-BR.

In some embodiments, an existing aperiodic trigger states can be used for both an aperiodic CSI report and a UEI-BR, in a way that some of the CSI report configurations associated to the trigger state are configured with a report type of aperiodic CSI and the remaining CSI report configurations associated to the same trigger state are configured with a report type of UEI-BR.

In some embodiments (for example, at operation 407 of FIG. 4), the UE receives a DCI carried in a PDCCH that schedules the beam report in the PUSCH. In embodiments such as these, the DCI indicates a dynamic grant for the beam report transmission. The DCI indicates a trigger state and/or a slot offset index. For example, in some embodiments, a first field in the DCI indicates a trigger state that is associated to at least one CSI report configuration for UEI-BR. For the indicated trigger state, a second field in DCI indicates an index of slot offset (e.g., value 0 indicates the first slot offset value in the slot offset list of each CSI report configuration, value 1 indicates the second slot offset value in the slot offset list of each CSI report configuration, etc.).

In some embodiments, one single slot offset is selected among all indicated slot offsets. For instance, in some embodiments, among all the indicated slot offset values of all CSI report configurations associated to the indicated trigger state, the maximum value is selected to determine the timing of PUSCH transmission. Specifically, when the UE is scheduled to transmit a PUSCH with no transport block and with a CSI report(s) by a ‘CSI request’ field on a DCI, the ‘Time domain resource assignment’ field value m of the DCI provides a row index m+1 to the allocated table as defined in Tables 1 and 2 below. The slot offset K₂ value is determined as

$${K}_{2} = {max}_{j} {Y}_{j} ( m + 1 ) ,$$

where Yⱼ, j=0, . . . , N_{Rep}−1 are the corresponding list entries of the higher layer parameter
reportSlotOffsetListDCI-0-2 or reportSlotOffsetListDCI-0-2-r17, if PUSCH is scheduled by DCI format 0_2 and reportSlotOffsetListDCI-0-2 or reportSlotOffsetListDCI-0-2-r17 is configured;
reportSlotOffsetListDCI-0-1 or reportSlotOffsetListDCI-0-1-r17, if PUSCH is scheduled by DCI format 0_1 or 0_3 and reportSlotOffsetListDCI-0-1 or reportSlotOffsetListDCI-0-1-r17 is configured;
reportSlotOffsetList or reportSlotOffsetList-r17, otherwise;
   in CSI-ReportConfig for the N_{Rep} triggered CSI Reporting Settings and Yⱼ(m+1) is the (m+1)th entry of Yⱼ including the omitted CSI Reporting Settings triggered for non-active DL BWPs, where the UE does not expect that (m+1) is larger than 16.

TABLE 1
Default PUSCH time domain resource allocation A for normal CP

| | PUSCH | | | |
|---|---|---|---|---|
| | mapping | | | |
| Row index | type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

TABLE 2
Default PUSCH time domain resource
allocation A for extended CP

| | PUSCH | | | |
|---|---|---|---|---|
| | mapping | | | |
| Row index | type | K₂ | S | L |
| 1 | Type A | j | 0 | 8 |
| 2 | Type A | j | 0 | 12 |
| 3 | Type A | j | 0 | 10 |
| 4 | Type B | j | 2 | 10 |
| 5 | Type B | j | 4 | 4 |
| 6 | Type B | j | 4 | 8 |
| 7 | Type B | j | 4 | 6 |
| 8 | Type A | j + 1 | 0 | 8 |
| 9 | Type A | j + 1 | 0 | 12 |
| 10 | Type A | j + 1 | 0 | 10 |
| 11 | Type A | j + 2 | 0 | 6 |
| 12 | Type A | j + 2 | 0 | 12 |
| 13 | Type A | j + 2 | 0 | 10 |
| 14 | Type B | j | 8 | 4 |
| 15 | Type A | j + 3 | 0 | 8 |
| 16 | Type A | j + 3 | 0 | 10 |

In some embodiments, among all the indicated slot offset values of all CSI report configurations associated to the indicated trigger state, the minimum value is selected to determine the timing of PUSCH transmission. In some embodiments, among all the indicated slot offset values of the CSI report configurations configured with report type UEI-BR associated to the indicated trigger state, the maximum value is selected to determine the timing of PUSCH transmission. In some embodiments, among all the indicated slot offset values of the CSI report configurations configured with report type UEI-BR associated to the indicated trigger state, the minimum value is selected to determine the timing of PUSCH transmission.

In some embodiments, (for example, at operation 409 of FIG. 4), the UE transmits the beam report in a PUSCH using the dynamic grant indicated in the DCI at the slot corresponding to the selected single slot offset. In embodiments such as these, the report content can include an indication of the measured resource/beam (e.g., the index of a CSI-RS resource/beam or SSB resource/beam) that fulfils the evaluation event and/or the report quantity of the resource (e.g., a measured RSRP). If the indicated trigger state in the DCI includes the one or multiple CSI report configurations for UEI-BM, the report can include measurement result(s) of other measured resource(s)/beam(s) that are configured in the measurement resource set(s) for the UEI-BR regardless of whether the measured resource/beam fulfils an evaluation event or not. For example, the report can include the index(es) and/or the measured RSRP values of up to N measured resource(s)/beams(s), where N is configured by a parameter in the UEI-BR configuration. In some embodiments, the UE can report measured resource(s)/beam(s) associated to the indicated trigger state only. Alternatively, in some embodiments, the UE can report any measured resource(s)/beam(s) configured for UEI-BR. In some embodiments, the UE can report measured resource(s)/beam(s) associated to one or multiple CSI report configurations which can be indicated in a DCI field (e.g., the DCI received at operation 407 of FIG. 4 can include a bitmap with each bit of value 1 indicating that the measured resources/beams included in the corresponding CSI report configuration has to be reported and value 0 indicating not to be reported). If the indicated trigger state in the DCI includes the one or multiple CSI report configurations for aperiodic CSI report, the report content can also include the corresponding aperiodic CSI report(s).

In some embodiments, among all the indicated slot offset values of the CSI report configurations configured with report type UEI-BR associated to the indicated trigger state, all values are selected, and each different slot offset value indicates a timing of one PUSCH transmission so that multiple PUSCH transmissions for UEI-BR are scheduled. In some embodiments, a UE capability can be introduced to indicate the support of multiple slot offsets, which can be reported to the NW in a granularity of per UE or per frequency band or per frequency band combination or per feature combination, and/or differentiated between FR1 and FR2, and/or differentiated between FDD and TDD.

In some embodiments (for example at operation 409 of FIG. 4), the UE transmits a first beam report in a PUSCH at the slot corresponding to the minimum value among all indicated slot offsets, and a second beam report in a PUSCH at the slot corresponding to the second minimum value among all indicated slot offsets, etc. In embodiments such as these, the first report (or at least one of the reports) includes an indication of the measured resource/beam (e.g., an index of a CSI-RS resource/beam or SSB resource/beam) that fulfils the evaluation event and/or the report quantity of the resource/beam (e.g., avmeasured RSRP). If the indicated trigger state in the DCI includes the one or multiple CSI report configurations for UEI-BM, the report can include measurement result(s) of other measured resource(s)/beam(s) that are configured in the measurement resource set(s) for UEI-BR regardless the measured resource/beam fulfils an evaluation event or not. For example, each report can include the index(es) and/or the measured RSRP values of up to N measured resource(s)/beams(s), where N is configured by a parameter in UEI-BR configuration. In some embodiments, the UE can report measured resource(s)/beam(s) associated to the indicated trigger state only. Alternatively, in some embodiments, the UE can report any measured resource(s)/beam(s) configured for UEI-BR. In some embodiments, the UE can report measured resource(s)/beam(s) associated to one or multiple CSI report configurations which can be indicated in a DCI field. For example, the UE can report measured resource(s)/beam(s) associated to one or multiple CSI report configurations which can be indicated in a DCI field (e.g., the DCI received at operation 407 of FIG. 4 can include a bitmap with each bit of value 1 indicating that the measured resources/beams included in the corresponding CSI report configuration has to be reported and value 0 indicating not to be reported). If the indicated trigger state in the DCI includes the one or multiple CSI report configurations for aperiodic CSI report, the report content can also include the corresponding aperiodic CSI report(s).

In some embodiments, the number of configured UEI-BR triggering states is greater than 2\hat{ }(L)−1, where L is the number of bits in the DCI field that indicates the UEI-BR trigger state, and the UE receives a subselection indication. The subselection indication can be conveyed by a medium access control (MAC) control element (CE) to map up to 2\hat{ }(L)−1 UEI-BR trigger states to the codepoints of the UEI-BR trigger state field in DCI.

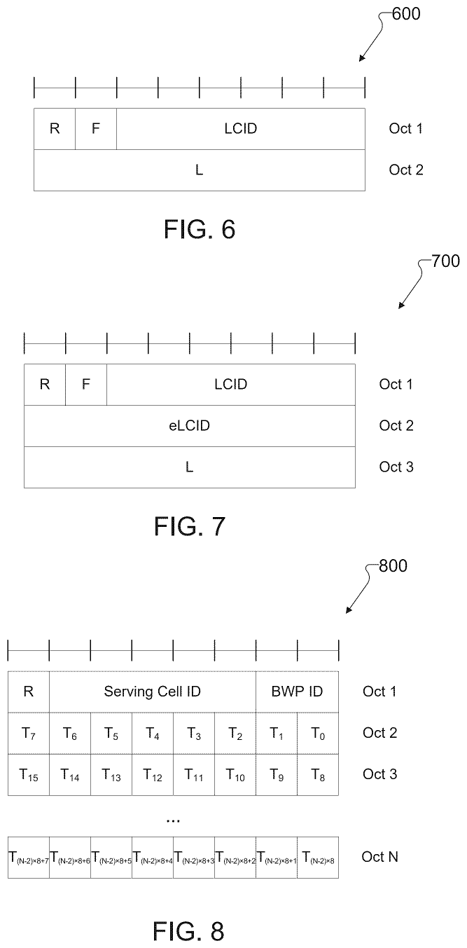

Some embodiment, the UEI-BR Trigger State Subselection MAC CE can be identified by a MAC subheader with a LCID as shown in FIG. 6 and Table 3, or a MAC subheader with an eLCID as shown in FIG. 7 and Table 4.

FIG. 6 illustrates an example MAC subheader with an LCID for UEI-BR Trigger State Subselection MAC CE 600 according to embodiments of the present disclosure. The embodiment of a MAC subheader of FIG. 6 is for illustration only. Different embodiments of a MAC subheader with an LCID for UEI-BR Trigger State Subselection MAC CE could be used without departing from the scope of this disclosure.

In the example of FIG. 6, L is the Length field that indicates the length of the corresponding variable-sized MAC CE in bytes. The size of the L field is indicated by the F field. F is the Format field that indicates the size of the Length field. The size of the F field is 1 bit. The value 0 indicates 8 bits of the Length field. The value 1 indicates 16 bits of the Length field. R is the reserved bit.

Although FIG. 6 illustrates one example MAC subheader with an LCID for UEI-BR Trigger State Subselection MAC CE 600, various changes may be made to FIG. 6. For example, various changes to size of the header could be made, etc. according to particular needs.

TABLE 3
Values of LCID for DL-SCH

| Codepoint/Index | LCID values |
|---|---|
| 54 | Aperiodic CSI Trigger State Subselection |
| X (e.g., an | UEI-BR Trigger State Subselection |
| integer from | |
| 35 to 46) | |

FIG. 7 illustrates another example MAC subheader with an LCID for UEI-BR Trigger State Subselection MAC CE 700 according to embodiments of the present disclosure. The embodiment of a MAC subheader of FIG. 7 is for illustration only. Different embodiments of a MAC subheader with an LCID for UEI-BR Trigger State Subselection MAC CE could be used without departing from the scope of this disclosure.

In the example of FIG. 7, L is the Length field that indicates the length of the corresponding variable-sized MAC CE in bytes. The size of the L field is indicated by the F field. F is the Format field that indicates the size of the Length field. The size of the F field is 1 bit. The value 0 indicates 8 bits of the Length field. The value 1 indicates 16 bits of the Length field. The LCID in FIG. 7 is set to 34 indicating the presence of the one-octet eLCID field. R is the reserved bit.

Although FIG. 7 illustrates one example MAC subheader with an LCID for UEI-BR Trigger State Subselection MAC CE 700, various changes may be made to FIG. 7. For example, various changes to size of the header could be made, etc. according to particular needs.

TABLE 4
Values of one-octet eLCID for DL-SCH

| Codepoint | Index | LCID values |
|---|---|---|
| Y (e.g., an | Z (e.g., an | UEI-BR Trigger State |
| integer from 0 | integer from | Subselection |
| to 215) | 64 to 279) | |

In some embodiments, the UEI-BR Trigger State Subselection MAC CE has a variable size including the fields shown in FIG. 8.

FIG. 8 illustrates example UEI-BR Trigger State Subselection MAC CE 800 according to embodiments of the present disclosure. The embodiment of a MAC CE of FIG. 8 is for illustration only. Different embodiments of a UEI-BR Trigger State Subselection MAC CE could be used without departing from the scope of this disclosure.

In the example of FIG. 8, the UEI-BR Trigger State Subselection MAC CE 800 includes the following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field. The length of the BWP ID field is 2 bits;
Tᵢ: This field indicates the selection status of the UEI-BR Trigger States configured within UEI-BR-TriggerStateList. T₀ refers to the first trigger state within the list, T₁ to the second one, etc. If the list does not contain an entry with index i, the MAC entity shall ignore the Tᵢ field. The Tᵢ field is set to 1 to indicate that the UEI-BR Trigger State i shall be mapped to a codepoint of the DCI field that indicates the UEI-BR trigger state. The codepoint to which the UEI-BR Trigger State is mapped is determined by its ordinal position among all the UEI-BR Trigger States with the Tᵢ field set to 1 (i.e., the first UEI-BR Trigger State with the Tᵢ field set to 1 shall be mapped to the codepoint value 1, the second UEI-BR Trigger State with Tᵢ field set to 1 shall be mapped to the codepoint value 2, etc.). The maximum number of mapped UEI-BR Trigger States is 63;
R: Reserved bit, set to 0.

Although FIG. 8 illustrates one example UEI-BR Trigger State Subselection MAC CE 800, various changes may be made to FIG. 8. For example, various changes to the number of included octets could be made, etc. according to particular needs.

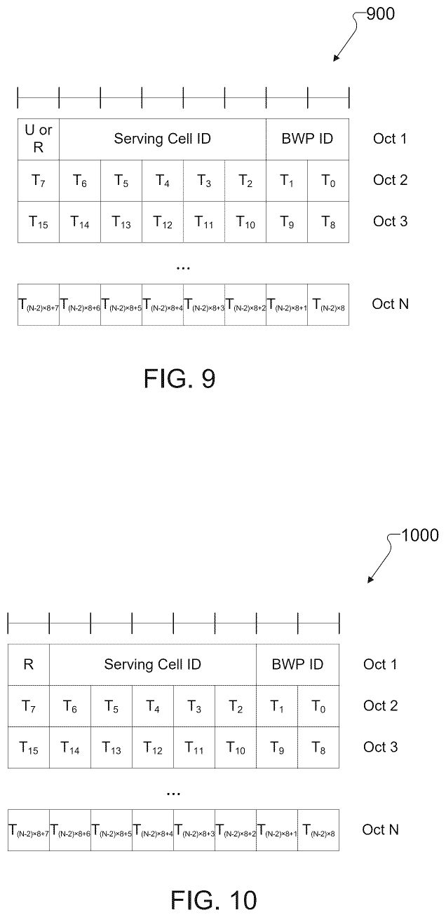

In some embodiments, an existing Aperiodic CSI Trigger State Subselection MAC CE (e.g., as specified in GPP TS 38.321) can be enhanced to indicate UEI-BR trigger state subselection. That is to say, the reserved bit is repurposed to indicate if the MAC CE is used to indicate subselection of Aperiodic CSI trigger states or UEI-BR trigger states. In embodiments such as these, the Aperiodic CSI Trigger State Subselection MAC CE is identified by a MAC subheader with LCID as shown in FIG. 6 and Table 3. It has a variable size including the fields shown in FIG. 9.

FIG. 9 illustrates example Aperiodic CSI Trigger State Subselection MAC CE with U field 900 according to embodiments of the present disclosure. The embodiment of a MAC CE of FIG. 9 is for illustration only. Different embodiments of an Aperiodic CSI Trigger State Subselection MAC CE with U field could be used without departing from the scope of this disclosure.

In the example of FIG. 9, the Aperiodic CSI Trigger State Subselection MAC CE includes the following fields:
U: this field indicates whether the MAC CE is used to indicate subselection of Aperiodic CSI trigger states or UEI-BR trigger states. The U field set to 1 indicates the subselection of UEI-BR trigger states. The U field set to 0 indicates the subselection of Aperiodic CSI trigger states. This field is present if a UEI-BR trigger state list is configured for UEI BR, otherwise this field is absent, and R bit is present instead.
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field. The length of the BWP ID field is 2 bits;
Ti: This field indicates the selection status of the Aperiodic Trigger States configured within aperiodicTriggerStateList. T0 refers to the first trigger state within the list, T1 to the second one and so on. If the list does not contain entry with index i, MAC entity shall ignore the Ti field. The Ti field is set to 1 to indicate that the Aperiodic Trigger State i shall be mapped to the codepoint of the DCI CSI request field. The codepoint to which the Aperiodic Trigger State is mapped is determined by its ordinal position among all the Aperiodic Trigger States with Ti field set to 1, (i.e., the first Aperiodic Trigger State with Ti field set to 1 shall be mapped to the codepoint value 1, second Aperiodic Trigger State with Ti field set to 1 shall be mapped to the codepoint value 2, etc.). The maximum number of mapped Aperiodic Trigger States is 63;
R: Reserved bit, set to 0.

Although FIG. 9 illustrates one example Aperiodic CSI Trigger State Subselection MAC CE with U field 900, various changes may be made to FIG. 9. For example, various changes to the number of included octets could be made, etc. according to particular needs.

In some embodiments, either a CSI-RS resource set(s) or SSB resource set(s) is configured for measurement in a CSI report configuration for UEI-BR, and different resource set(s) can be configured in different CSI report configurations for UEI-BR. In embodiments such as these, for each CSI report configuration for which the report type is configured as UEI-BR, the NW can configure only one type of measurement resource set(s), either CSI-RS resource set(s) or SSB resource set(s), for UEI-BR.

In some embodiments, for each CSI report configuration for which the report type is configured as UEI-BR, if CSI-RS resource set(s) are configured as UEI-BR measurement resource/RS set(s), CRI (CSI-RS resource indicator) and RSRP are configured as report quantities. In embodiments such as these, if SSB resource set(s) are configured as UEI-BR measurement resource/RS set(s), the SSB index (or SSBRI, i.e., SSB resource indicator) and RSRP are configured as report quantities.

In some embodiments, for each CSI report configuration for which the report type is configured as UEI-BR, the UE ignores one or more configurations of time domain measurement restriction (e.g., timeRestrictionForChannelMeasurements, timeRestrictionForInterferenceMeasurements), turning on/off group-beam based reporting (e.g., groupBasedBeamReporting), subband size, if configured.

In some embodiments, the UE can be configured with a list of CSI trigger states by a received RRCReconfiguration message. In embodiments such as these, the CSI-AperiodicTriggerStateList IE is used to configure the UE with a list of CSI trigger states for aperiodic CSI and UE-initiated CSI. Each codepoint of the DCI field “CSI request” is associated with one trigger state. Upon reception of the value associated with a trigger state for aperiodic CSI, the UE will perform measurement of CSI-RS, CSI-IM and/or SSB (reference signals) and aperiodic reporting on L1 according to all entries in the associatedReportConfigInfoList for that trigger state. Upon reception of the value associated with a trigger state for UE-initiated CSI, UE sends a UE-initiated CSI report for the associated CSI-ReportConfig on a PUSCH indicated in the DCI by which the trigger state is indicated.

In some embodiments, the network may select among the configured CSI trigger states for aperiodic CSI reporting and/or UEI-initiated CSI reporting of a Serving Cell by sending the Aperiodic CSI Trigger State Subselection MAC CE. In some embodiments Aperiodic CSI Trigger State Subselection is used to select CSI trigger states for aperiodic CSI reporting and UEI-initiated CSI reporting if the UE is configured with UE-initiated CSI reporting by indicating event-triggered report type in the CSI report configuration. In some embodiments, the MAC entity of the UE shall indicate to lower layers the information regarding Aperiodic CSI trigger State Subselection MAC CE if the MAC entity receives an Aperiodic CSI trigger State Subselection MAC CE on a Serving Cell.

In some embodiments, an existing Aperiodic CSI Trigger State Subselection MAC CE (e.g., as specified in 3GPPP TS 38.321) may be used to indicate CSI trigger state subselection for aperiodic CSI and UE-initiated CSI. In embodiments such as these, the Aperiodic CSI Trigger State Subselection MAC CE is identified by a MAC subheader with LCID as shown in FIG. 6 and Table 3. It has a variable size comprising the fields shown in FIG. 10.

FIG. 10 illustrates example Aperiodic CSI Trigger State Subselection MAC CE 1000 according to embodiments of the present disclosure. The embodiment of a MAC CE of FIG. 10 is for illustration only. Different embodiments of an Aperiodic CSI Trigger State Subselection MAC CE could be used without departing from the scope of this disclosure.

In the example of FIG. 10, the Aperiodic CSI Trigger State Subselection MAC CE includes the following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field. The length of the BWP ID field is 2 bits;
Ti: This field indicates the selection status of the CSI Trigger States configured within csi-aperiodicTriggerStateList. T0 refers to the first trigger state within the list, T1 to the second one, etc. If the list does not contain entry with index i, MAC entity shall ignore the Ti field. The Ti field is set to 1 to indicate that the CSI Trigger State i shall be mapped to the codepoint of the DCI CSI request field. The codepoint to which the CSI Trigger State is mapped is determined by its ordinal position among all the CSI Trigger States with Ti field set to 1 (i.e., the first CSI Trigger State with Ti field set to 1 shall be mapped to the codepoint value 1, second CSI Trigger State with Ti field set to 1 shall be mapped to the codepoint value 2, etc.). The maximum number of mapped CSI Trigger States is 63.
R: Reserved bit, set to 0.

Although FIG. 10 illustrates one example Aperiodic CSI Trigger State Subselection MAC CE 1000, various changes may be made to FIG. 10. For example, various changes to the number of included octets could be made, etc. according to particular needs.

In some embodiments, if a multi-panel scheme with spatial division multiplexing (SDM) is configured for single DCI (sDCI) multiple TRP (mTRP) transmission with both a first TCI state and a second TCI state, and if one of the TCI states is associated with a TAG for which the timeAlignmentTimer is not running, the MAC entity shall not perform any uplink transmission using the other TCI state for the multi-panel SDM scheme.

In some embodiments, for connected mode discontinuous reception (DRX) for UE power saving, (i) if DCP monitoring is configured for the active DL BWP, (ii) if the current symbol n occurs within drx-onDurationTimer duration, and (iii) if drx-onDurationTimer associated with the current DRX cycle is not started:
(i) if the MAC entity would not be in Active Time considering grants/assignments/DRX Command MAC CE/Long DRX Command MAC CE received and Scheduling Request sent until 4 ms prior to symbol n when evaluating all DRX Active Time conditions, and (ii) if allowCSI-SRS-Tx-MulticastDRX-Active is not configured, or if cfr-ConfigMulticast is not configured for any of the active BWP(s) of the Serving Cell(s), or if all multicast DRXes would not be in Active Time considering multicast assignments/DRX Command MAC CE for MBS multicast received until 4 ms prior to symbol n when evaluating all DRX Active Time conditions and all multicast sessions are configured with multicast DRX:
   the UE does not transmit periodic SRS and semi-persistent SRS;
   the UE does not report semi-persistent CSI configured on the PUSCH;
   the UE does not report semi-persistent CSI on the PUCCH;
   the UE does not transmit a UE Initiated Report Indication on the PUCCH and the associated mode-B UE-initiated CSI reporting on the PUSCH if the PUCCH or the PUSCH resource is not in Active Time;
   if ps-TransmitPeriodicL1-RSRP is not configured with value true, the UE does not report periodic CSI that is L1-RSRP on the PUCCH; and
   if ps-TransmitOtherPeriodicCSI is not configured with value true, the UE does not report periodic CSI that is not L1-RSRP on PUCCH.

### Otherwise:

(i) in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and (ii) if allowCSI-SRS-Tx-MulticastDRX-Active is not configured, or if cfr-ConfigMulticast is not configured for any of the active BWP(s) of the Serving Cell(s), or, in current symbol n, if all multicast DRXes corresponding to the DRX group would not be in Active Time considering multicast assignments/DRX Command MAC CE for MBS multicast received until 4 ms prior to symbol n when evaluating all DRX Active Time conditions and all multicast sessions corresponding to the DRX group are configured with multicast DRX:
   the UE does not transmit periodic SRS and semi-persistent SRS in this DRX group;
   the UE does not report CSI on the PUCCH, and semi-persistent CSI configured on the PUSCH in this DRX group; and
   the UE does not transmit a UE Initiated Report Indication on the PUCCH and the associated mode-B UE-initiated CSI reporting on the PUSCH in this DRX group if the PUCCH or the PUSCH resource is not in Active Time.
if CSI masking (csi-Mask) is setup by upper layers:
   (i) in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause, and (ii) if allowCSI-SRS-Tx-MulticastDRX-Active is not configured, or if cfr-ConfigMulticast is not configured for any of the active BWP(s) of the Serving Cell(s), or, in current symbol n, if drx-onDurationTimerPTM(s) of all multicast DRXes corresponding to the DRX group would not be running considering DRX Command MAC CE for MBS multicast received until 4 ms prior to symbol n when evaluating all DRX Active Time conditions and all multicast sessions corresponding to the DRX group are configured with multicast DRX:
      the UE does not report CSI on PUCCH in this DRX group; and
      the UE does not transmit UE-initiated CSI Report Indication on PUCCH and/or UE-initiated CSI report on PUSCH using DG or CG in this DRX group.

In some embodiments, for cell DTX for network energy saving, if cell DRX is activated and the Serving Cell is not in the cell DRX Active Period:
the UE does not instruct the physical layer to signal a SR on a PUCCH resource for SR;
the UE does not increment the SR_COUNTER for a SR;
the UE does not start the sr-ProhibitTimer for a SR;
the UE does not deliver any configured uplink grant and the associated HARQ information to the HARQ entity;
the UE does not instruct a HARQ process associated with a configured uplink grant to trigger a new transmission or a retransmission;
the UE does not report CSI on the PUCCH, and semi-persistent CSI configured on the PUSCH;
the UE does not transmit a UE Initiated Report Indication on the PUCCH for mode-A UE-initiated CSI reporting; and
the UE does not transmit a UE Initiated Report Indication on the PUCCH and the associated mode-B UE-initiated CSI reporting on the PUSCH if the PUCCH or the PUSCH resource of the Serving Cell is not in the cell DRX Active Period.

In some embodiments, for timing alignment handling, when a timeAlignmentTimer expires:
(i) if the timeAlignmentTimer is associated with a PTAG and the SpCell is not configured with two PTAGs, or (ii) if the timeAlignmentTimer is associated with a PTAG, the SpCell is configured with two PTAGs, and the timeAlignmentTimer associated with the other PTAG is not running:
   the UE flushes all HARQ buffers for all Serving Cells;
   the UE notifies RRC to release PUCCH for all Serving Cells, if configured;
   the UE notifies RRC to release SRS for all Serving Cells, if configured;
   the UE clears any configured downlink assignments and configured uplink grants;
   the UE clears any PUSCH resource for semi-persistent CSI reporting
   the UE considers all running timeAlignmentTimers as expired; and
   the UE maintains the N_{TA} of all TAGs.
Otherwise
   (i) if the timeAlignmentTimer is associated with a TAG for an SCell configured with only this TAG, or (ii) if the timeAlignmentTimer is associated with a TAG for an SCell, and if the SCell is configured with two TAGs and the timeAlignmentTimer associated with the other TAG is not running:
      the UE flushes all HARQ buffers for all such SCells;
      the UE notifies RRC to release PUCCH, if configured for all such SCells;
         (i) if the PUCCH resource included in a CSI-ReportConfig for mode-B UE-initiated CSI reporting is configured on such a SCell, and (ii) if the configured grant Type 1 included in this CSI-ReportConfig is not configured for another CSI-ReportConfig which includes a PUCCH resource on a Serving Cell belonging to a TAG with the timeAlignmentTimer running, the UE clears the configured grant Type 1 included in this CSI-ReportConfig.
      the UE notifies RRC to release SRS, if configured for all such SCells
      the UE clears any configured downlink assignments and configured uplink grants for all such SCells
      the UE clears any PUSCH resource for semi-persistent CSI reporting for all such SCells; and
      the UE maintains the N_{TA} of this TAG.

In some embodiments, for UL timing alignment handling, when a timeAlignmentTimer expires:
(i) if the timeAlignmentTimer is associated with a PTAG and the SpCell is not configured with two PTAGs, or (ii) if the timeAlignmentTimer is associated with a PTAG, the SpCell is configured with two PTAGs, and the timeAlignmentTimer associated with the other PTAG is not running:
   the UE flushes all HARQ buffers for all Serving Cells;
   the UE notifies RRC to release the PUCCH for all Serving Cells, if configured;
   the UE notifies RRC to release SRS for all Serving Cells, if configured;
   the UE clears any configured downlink assignments and configured uplink grants;
   the UE clears any PUSCH resource for semi-persistent CSI reporting;
   the UE considers all running timeAlignmentTimers as expired; and
   the UE maintains N_{TA} of all TAGS.
Otherwise:
   (i) if the timeAlignmentTimer is associated with a TAG for an SCell configured with only this TAG; or (ii) if the timeAlignmentTimer is associated with a TAG for an SCell, and if the SCell is configured with two TAGs and the timeAlignmentTimer associated with the other TAG is not running:
      the UE flushes all HARQ buffers for all such SCells;
      the UE notifies RRC to release the PUCCH, if configured for all such SCells;
      the UE notify RRC to release SRS, if configured for all such SCells;
      the UE clears any configured downlink assignments and configured uplink grants for all such SCells;
         (i) if the configured grant Type 1 included in a CSI-ReportConfig for mode-B UE-initiated CSI reporting is configured on such a SCell and (ii) if the PUCCH resource included in this CSI-ReportConfig is not configured to be used for other UCI transmission, the UE releases the PUCCH resource included in this CSI-ReportConfig;
      the UE clears any PUSCH resource for semi-persistent CSI reporting for all such SCells; and
      the UE maintains N_{TA} of this TAG.

In some embodiments, upon receiving a PUCCH release request from lower layers, if the indicated serving cell from the lower layer is referred to by pucch-Cell included in CSI-ReportUE-IBR of an associated CSI-ReportConfig, the UE releases pucch-Resource indicated in the associated CSI-ReportUE-IBR.

Is some embodiments, for UE initiated CSI reporting configured with mode-B reporting, if the PUCCH resource and Type1 CG resource included in the report configuration are configured on two different cells that belongs to different TAGs, and if the TAT for the sTAG for the Type1 CG resource is expired while the TAT for the TAG for the PUCCH resource is running, the UE does not transmit a UE Initiated Report Indication on the PUCCH resource for this report configuration.

In some embodiments, for an SCell activation/deactivation operation, if an SCell is deactivated and if the configured grant Type 1 included in a CSI-ReportConfig for mode-B UE-initiated CSI reporting is configured on the SCell, the UE does not transmit a UE Initiated Report Indication on the PUCCH for this CSI-ReportConfig.

In some embodiments, for a BWP activation/deactivation operation, if a BWP is deactivated and if the configured grant Type 1 included in a CSI-ReportConfig for mode-B UE-initiated CSI reporting is configured on the BWP, the UE does not transmit a UE Initiated Report Indication on the PUCCH for this CSI-ReportConfig.

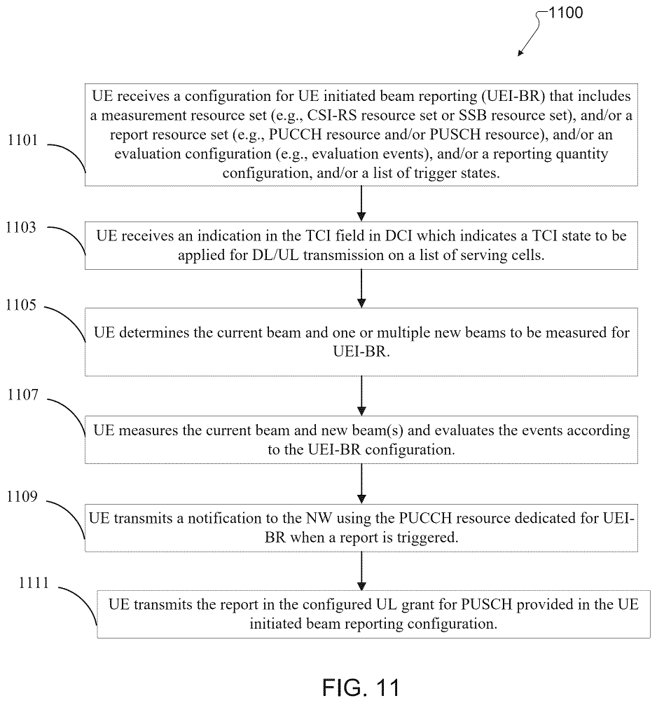

FIG. 11 illustrates an example UE procedure for cross-cell UEI-BR 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a UE procedure for cross-cell UEI-BR could be used without departing from the scope of this disclosure.

In the example of FIG. 11, the procedure 1100 begins at operation 1101. At operation 1101, a UE (such as UE 116 of FIG. 1) receives a configuration for UEI-BR (e.g., in UE dedicated RRC signalling). The UEI-BR configuration can include a measurement resource (e.g., CSI-RS resource or SSB resource), and/or a report resource (e.g., PUCCH resource and/or PUSCH resource), and/or an evaluation configuration (e.g., evaluation events), and/or a reporting quantity configuration, and/or a list of trigger states. Each trigger state can indicate a list of slot offsets. Each slot offset refers to a time gap between the slot that DCI schedules UE initiated beam reporting and the slot that UE transmits the beam report.

For example, in some embodiments, the RRC parameter/field is present if the UE is configured with simultaneous TCI state update by which TCI state(s) are activated/deactivated/indicated simultaneously for a list of serving cells; otherwise, the RRC parameter/field can be absent or optional. In some embodiments, the RRC parameter/field is present if the indicated TCI state is applied on more than one serving cells; otherwise, the RRC parameter/field can be absent or optional. In some embodiments, the RRC parameter/field is present if the UE is configured with more than one serving cells including DL/UL TCI state lists; otherwise, the RRC parameter/field can be absent or optional.

At operation 1103, the UE receives an indication in the TCI field in DCI which indicates a TCI state to be applied for DL/UL transmission on a list of serving cells.

At operation 1105, the UE determines the current beam and one or multiple new beams to be measured for UEI-BR. The UE determines the one or multiple new beams from the measurement resource (e.g., CSI-RS resource or SSB resource) included in the UEI-BR configuration.

In some embodiments, the UEI-BR configuration can include an RRC parameter/field which indicates a serving cell, on which the current beam RS is located, from the list of serving cells for which the indicated TCI state is applied. The RRC parameter/field can be defined as a serving cell index. In embodiments such as these, the UE determines the current beam type (i.e., CSI-RS or SSB) based on the configured new beam(s) type such that the current beam and the new beam(s) are of the same type. If the new beam RS is CSI-RS, the UE determines the current beam RS is the CSI-RS configured for the indicated TCI state; if the new beam RS is SSB, the UE determines the current beam RS is the SSB configured as quasi-co-located to the CSI-RS of the indicated TCI state. The UE determines one serving cell, from the list of serving cells for which the indicated TCI state is applied, which has the same serving cell index as the value of the RRC parameter/field.

At operation 1107, the UE measures the current beam and new beam(s) and evaluates the events according to the UEI-BR configuration.

At operation 1109, the UE transmits a notification to the NW using the PUCCH resource dedicated for UEI-BR when a report is triggered. The notification informs the NW that a UEI-BR is triggered.

At operation 1111, the UE transmits the report in the configured UL grant for PUSCH provided in the UE initiated beam reporting configuration.

Although FIG. 11 illustrates one example UE procedure for cross-cell UEI-BR 1100, various changes may be made to FIG. 11. For example, while shown as a series of operations, various operations in FIG. 11 could overlap, occur in parallel, occur in a different order, occur any number of times, be omitted, or replaced by other operations.

In some embodiments, each report configuration of UEI-BR includes a PUCCH resource ID that indicates the PUCCH resource to be used by the UE to transmit a report notification upon a report that is triggered. For example, in some embodiments, the PUCCH resource ID is a unique ID for a PUCCH resource across all serving cells. In embodiment such as these, the UE identifies the PUCCH resource on a BWP of a serving cell indicated by the global PUCCH resource ID. In some embodiments, the PUCCH resource ID is a unique ID for a PUCCH resource across all BWPs of a serving cell. In embodiment such as these, a serving cell index is configured together with the PUCCH resource ID so that the UE identifies the PUCCH resource on a serving cell indicated by the serving cell index. In some embodiments, the PUCCH resource ID is a local ID for each BWP. In embodiment such as these, a serving cell index and a BWP ID are configured together with the PUCCH resource ID so that the UE identifies the PUCCH resource on a BWP of a serving cell indicated by the BWP ID and the serving cell index.

In some embodiments, each report configuration of UEI-BR includes a PUSCH resource ID that indicates the PUSCH configured grant (CG) to be used by UE to transmit a report for mode-B UEI BR. The PUSCH CG resource ID is a local ID for each BWP. The PUSCH CG resource ID refers to the CG resource identified by the ID on every configured BWP where the CG resource ID is configured, so that UE identifies all the PUSCH CG resource on all the BWPs where the CG resource ID is configured. In this case, if UEI-BR is triggered according to a report configuration for a serving cell and a report notification has been transmitted on PUCCH, the UE transmits the report on the current active BWP of that serving cell using the PUSCH CG resource on that active BWP which is identified by the PUSCH CG resource ID included in the report configuration.

In some embodiments, each report configuration of UEI-BR includes a PUSCH resource ID that indicates the PUSCH configured grant (CG) to be used by the UE to transmit a report for mode-B UEI BR. The PUSCH CG resource ID is a local ID for each BWP. A BWP ID is configured together with the PUSCH CG resource ID in each report configuration of UEI BR, so that the UE identifies the PUSCH CG resource on the BWP indicated by the BWP ID. In this case, if UEI-BR is triggered according to a report configuration for a serving cell and a report notification has been transmitted on PUCCH, and if the CG resource identified by the PUSCH CG resource ID included in the report configuration is configured with BWP ID of the current active BWP (i.e., the identified CG resource is on the current active BWP), the UE transmits the report on the current active BWP of that serving cell using the PUSCH CG resource on the active BWP which is identified by the PUSCH CG resource ID included in the report configuration. If UEI-BR is triggered according to a report configuration for a serving cell and a report notification has been transmitted on PUCCH, and if the CG resource identified by the PUSCH CG resource ID included in the report configuration is configured with a different BWP ID than the current active BWP (i.e., the identified CG resource is not on the current active BWP), the UE monitors the PDCCH to receive a PUSCH dynamic grant (DG) to transmit the report. Alternatively, in some embodiments, the UE sends a scheduling request. Alternatively, in some embodiments, the UE discards the report.

In some embodiments, each report configuration of UEI-BR includes a PUSCH resource ID that indicates the PUSCH configured grant (CG) to be used by the UE to transmit a report for mode-B UEI BR. The PUSCH CG resource ID is a unique ID across all serving cells of a MAC entity. The PUSCH CG resource ID included in a report configuration should refer to a PUSCH CG resource on the same serving cell where the report configuration is configured. The PUSCH CG resource ID refers to the CG resource identified by the unique ID on the MAC entity, so that UE identifies the PUSCH CG resource on a BWP of a serving cell of the MAC entity where the CG resource ID is configured. In this case, if UEI-BR is triggered according to a report configuration for a serving cell and a report notification has been transmitted on PUCCH, and if the CG resource identified by the PUSCH CG resource ID included in the report configuration is on the current active BWP of the serving cell for which UEI BR is triggered, the UE transmits the report on the current active BWP of that serving cell using the PUSCH CG resource. If UEI-BR is triggered according to a report configuration for a serving cell and a report notification has been transmitted on the PUCCH, and if the CG resource identified by the PUSCH CG resource ID included in the report configuration is not on the current active BWP of the serving cell for which UEI-BR is triggered, the UE monitors the PDCCH to receive a PUSCH dynamic grant (DG) to transmit the report. Alternatively, in some embodiments, the UE switches to the BWP on which the identified PUSCH CG resource is configured and transmits the report on the switched BWP of that serving cell using the identified PUSCH CG resource. Alternatively, in some embodiments, the UE sends a scheduling request. Alternatively, in some embodiments, the UE discards the report.

In some embodiments, the MAC entity shall not include a configured grant Type 1 provided by RRC for UE-initiated/event-triggered beam reporting as an uplink grant in UL-SCH data transfer procedures.

In some embodiments, when DRX is configured, the Active Time for Serving Cells in a DRX group includes the time while a PDCCH indicating a new transmission addressed to the C-RNTI of the MAC entity has not been received after transmitting UCI on PUCCH for UE-initiated/event-triggered beam reporting.

In some embodiments, if an SCell is configured with sCellState set to activated upon SCell configuration, or an SCell Activation/Deactivation MAC CE or an Enhanced SCell Activation/Deactivation MAC CE is received activating the SCell:
if the SCell was deactivated prior to receiving this Enhanced SCell Activation/Deactivation MAC CE and a TRS is indicated for this SCell, a MAC entity indicates to lower layers the information regarding the TRS.
(i) if the SCell was deactivated prior to receiving this SCell Activation/Deactivation MAC CE or this Enhanced SCell Activation/Deactivation MAC CE, or (ii) if the SCell is configured with sCellState set to activated upon SCell configuration, if>if firstActiveDownlinkBWP-Id is not set to dormant BWP, the MAC entity activates the SCell according to the timing defined for MAC CE activation and according to the timing defined in for direct SCell activation (i.e., apply normal SCell operation) including:
   SRS transmissions on the SCell;
   CSI reporting for the SCell;
   UE-initiated/Event-triggered beam reporting for the SCell;
   PDCCH monitoring on the SCell;
   PDCCH monitoring for the SCell; and
   PUCCH transmissions on the SCell, if configured.
      If the SCell is deactivated:
the MAC entity does not transmit SRS on the SCell;
the MAC entity does not report CSI for the SCell;
the MAC entity does not transmit UE-initiated/event-triggered beam reporting for the SCell;
the MAC entity does not transmit on UL-SCH on the SCell;
the MAC entity does not transmit on RACH on the SCell;
the MAC entity does not monitor the PDCCH on the SCell;
the MAC entity does not monitor the PDCCH for the SCell; and
the MAC entity does not transmit PUCCH on the SCell.

In some embodiments, during an activated measurement gap, in the corresponding frequency range of the measurement gap configured by measGapConfig:
the MAC entity does not perform the transmission of HARQ feedback, SR, and CSI, and UE-initiated/event-triggered beam reporting;
the MAC entity does not report SRS;
the MAC entity does not transmit on UL-SCH except for Msg3 or the MSGA payload; and
if the ra-ResponseWindow or the ra-ContentionResolutionTimer or the msgB-ResponseWindow is running, or if there is an ongoing RACH-less LTM cell switch, or if there is an ongoing RACH-less handover, the MAC entity monitors the PDCCH.
Otherwise:
   the MAC entity does not monitor the PDCCH; and
   the MAC entity does not receive on DL-SCH.

In some embodiments, for each activated Serving Cell configured with a BWP:
if a BWP is activated and the active DL BWP for the Serving Cell is not the dormant BWP and the Serving Cell is not the PSCell of deactivated SCG:
   the MAC entity transmits on UL-SCH on the BWP;
   the MAC entity transmits on RACH on the BWP, if PRACH occasions are configured;
   the MAC entity monitors the PDCCH on the BWP;
   the MAC entity transmits PUCCH on the BWP, if configured;
   the MAC entity reports CSI for the BWP;
   the MAC entity transmits UE-initiated/event-triggered beam reporting for the BWP;
   the MAC entity transmits SRS on the BWP, if configured;
   the MAC entity receives DL-SCH on the BWP; and
   the MAC entity (re-)initializes any suspended configured uplink grants of configured grant Type 1 on the active BWP according to the stored configuration, if any, and to start in the symbol according to specified rules.
If a BWP is activated and the active DL BWP for the Serving Cell is dormant BWP:
   the MAC entity stops the bwp-InactivityTimer of this Serving Cell, if running;
   the MAC entity does not monitor the PDCCH on the BWP;
   the MAC entity does not monitor the PDCCH for the BWP;
   the MAC entity does not receive DL-SCH on the BWP;
   the MAC entity does not report CSI on the BWP, report CSI except aperiodic CSI for the BWP;
   the MAC entity does not transmit UE-initiated/event-triggered beam reporting on the BWP;
   the MAC entity does not transmit SRS on the BWP;
   the MAC entity does not transmit on UL-SCH on the BWP;
   the MAC entity does not transmit on RACH on the BWP;
   the MAC entity does not transmit PUCCH on the BWP;
   the MAC entity clears any configured downlink assignment and any configured uplink grant Type 2 associated with the SCell respectively;
   the MAC entity suspends any configured uplink grant Type 1 associated with the SCell;
   if configured, the MAC entity performs beam failure detection and beam failure recovery for the SCell if beam failure is detected; and
   if the SCell is configured as a scheduled cell in MC-DCI-SetOfCells and with the search space for DCI to schedule multiple cells of the same searchSpaceId as the serving cell in which MC-DCI-SetOfCells containing the SCell is configured, the MAC entity does not monitor the PDCCH for scheduling multiple cells for the set of cells in MC-DCI-SetOfCells including the SCell.
If a BWP is deactivated or the Serving Cell is PSCell of deactivated SCG:
   the MAC entity does not transmit on UL-SCH on the BWP;
   the MAC entity does not transmit on RACH on the BWP;
   the MAC entity does not monitor the PDCCH on the BWP;
   the MAC entity does not transmit PUCCH on the BWP;
   the MAC entity does not report CSI for the BWP;
   the MAC entity does not transmit UE-initiated/event-triggered beam reporting for the BWP;
   the MAC entity does not transmit SRS on the BWP;
   the MAC entity does not receive DL-SCH on the BWP;
   the MAC entity clears any configured downlink assignment and configured uplink grant of configured grant Type 2 on the BWP; and
   the MAC entity suspends any configured uplink grant of configured grant Type 1 on the inactive BWP.

In some embodiments, for the configured SCG:
if upper layers indicate that SCG is activated:
   if BFI_COUNTER>=beamFailureInstanceMaxCount for the PSCell or the timeAlignmentTimer associated with PTAG is not running, the MAC entity indicates to upper layers that a Random Access Procedure is needed for SCG activation;
   the MAC entity activates the SCG according to a defined timing;
   the MAC entity (re-)initializes any suspended configured uplink grants of configured grant Type 1 associated with this PSCell according to the stored configuration, if any, and to starts in the symbol according to specified rules; and
   the MAC entity applies normal SCG operation including:
      SRS transmissions on the PSCell;
      CSI reporting for the PSCell;
      UE-initiated/Event-triggered beam reporting for the PSCell;
      PDCCH monitoring on the PSCell;
      PUCCH transmissions on the PSCell;
      transmitting on RACH on the PSCell; and
      initializing Bj for each logical channel to zero.
if the SCG is deactivated:
   the MAC entity does not transmit SRS on the PSCell;
   the MAC entity does not report CSI for the PSCell;
   the MAC entity does not transmit UE-initiated/event-triggered beam reporting for the PSCell;
   the MAC entity does not transmit on UL-SCH on the PSCell;
   the MAC entity does not transmit PUCCH on the PSCell;
   the MAC entity does not transmit on RACH on the PSCell; and
   the MAC entity does not monitor the PDCCH on the PSCell.

In some embodiments, during the FR2 UL gap configured by ul-GapFR2-Config, the MAC entity, on the Serving Cell(s) of FR2 single CC and intra-band CA, or on the Serving Cell(s) of FR2 inter-band CA where the UE does not support tx-Support-UL-GapFR2, only performs transmission of:
a PRACH preamble;
UL-SCH for Msg3 or the MSGA payload;
UL-SCH for a configured grant;
a valid CSI report during an SCell activation procedure, where the valid CSI report is valid CQI with non-zero CQI index, when the time period between the UL gap colliding with CSI report of non-zero CQI and the slot where the SCell activation MAC CE or CSI report activation command is received is no less than 10 ms;
a valid L1 RSRP report during SCell activation procedure, where the valid L1 RSRP report is a non-lowest L1 RSRP, when the time period between UL gap colliding with L1 RSRP reporting and the slot where the SCell activation MAC CE or CSI report activation command is received is no less than 10 ms;
the PUCCH transmission for SR, and a link recovery request (LRR); and
UE-initiated/Event-triggered beam reporting.

In some embodiments, if cell DRX is activated and the Serving Cell is not in the cell DRX Active Period:
the MAC entity does not instruct the physical layer to signal a SR on a PUCCH resource for SR;
the MAC entity does not increment the SR_COUNTER for a SR;
the MAC entity does not start the sr-ProhibitTimer for a SR;
the MAC entity does not deliver any configured uplink grant and the associated HARQ information to the HARQ entity;
the MAC entity does not instruct a HARQ process associated with a configured uplink grant to trigger a new transmission or a retransmission;
the MAC entity does not report CSI on PUCCH, and semi-persistent CSI configured on PUSCH;
the MAC entity does not transmit UE-initiated/event-triggered beam reporting; and
if an emergency service is initiated by upper layers and this Serving Cell is the SpCell, the MAC entity initiates a random access procedure.

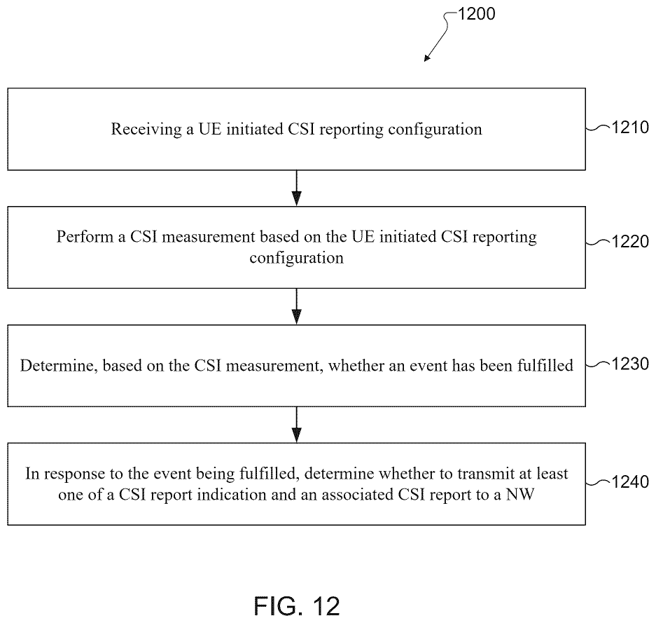

FIG. 12 illustrates another example method for UE-initiated beam reporting trigger states 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for UE-initiated beam reporting trigger states could be used without departing from the scope of this disclosure.

In the example of FIG. 12, method 1200 begins at step 1210. At step 1210, a UE (such as UE 116 of FIG. 1) receives a UE initiated CSI reporting configuration.

At step 1220, the UE performs a CSI measurement based on the UE initiated CSI reporting configuration.

At step 1230, the UE determines, based on the CSI measurement, whether an event has been fulfilled.

At step 1240, in response to the event being fulfilled, the UE determines whether to transmit at least one of a CSI report indication and an associated CSI report to a NW.

In some embodiments, the UE initiated CSI reporting configuration may be associated to a CSI trigger state dedicatedly for the UE initiated CSI reporting configuration. In embodiments such as these, the UE initiated CSI reporting configuration may include (i) one or more evaluation events and (ii) a list of slot offsets for mode-A UE initiated CSI reporting, and the fulfilled event may be an event from the one or more evaluation events.

In some embodiments, in response to a determination to transmit the CSI report indication, the UE may transmit the CSI report indication in a physical uplink control channel (PUCCH) resource, receive DCI indicating (i) a value associated with the CSI trigger state associated to the UE initiated CSI reporting configuration and (ii) a slot offset, and transmit the associated CSI report according to the UE initiated CSI reporting configuration to the NW on a PUSCH dynamic grant using the indicated slot offset.

In some embodiments, the UE may further receive an aperiodic CSI trigger state subselection MAC CE. In embodiments such as these, the aperiodic CSI trigger state subselection MAC CE may indicate a selected CSI trigger state including the CSI trigger state associated to the UE initiated CSI reporting configuration for mode-A UE-initiated CSI reporting.

In some embodiments, in response to a determination to transmit the associated CSI report to the NW, the UE may transmit the CSI report to the NW during a FR2 UL gap.

In some embodiments, cell DRX may be activated for a serving cell of the UE. In embodiments such as these, to determine whether to transmit at least one of the CSI report indication and the associated CSI report to the NW, the UE may determining whether the serving cell is in a cell DRX active period, and in response to a determination that the serving cell is not in the cell DRX active period, (i) refrain from transmitting the CSI report indication for mode-A UE initiated CSI reporting, and (ii) refrain from transmitting the CSI report indication and the associated CSI report for mode-B UE initiated CSI reporting.

In some embodiments, the UE may be operating in connected mode DRX. In embodiments such as these, to determine whether to transmit at least one of the CSI report indication and the associated CSI report to the NW, the UE may determine whether an uplink resource for transmitting the CSI report indication and an uplink resource for transmitting the associated CSI report are scheduled within a DRX active time of the UE, and in response to a determination that at least one of the uplink resource for transmitting the CSI report indication and the uplink resource for transmitting the associated CSI report are not scheduled within the DRX active time of the UE, refrain from transmitting the CSI report indication and the associated CSI report on the respective uplink resources.

Although FIG. 12 illustrates one example method for UE-initiated beam reporting trigger states 1200, various changes may be made to FIG. 12. For example, while shown as a series of steps, various steps in FIG. 12 could overlap, occur in parallel, occur in a different order, occur any number of times, be omitted, or replaced by other steps.

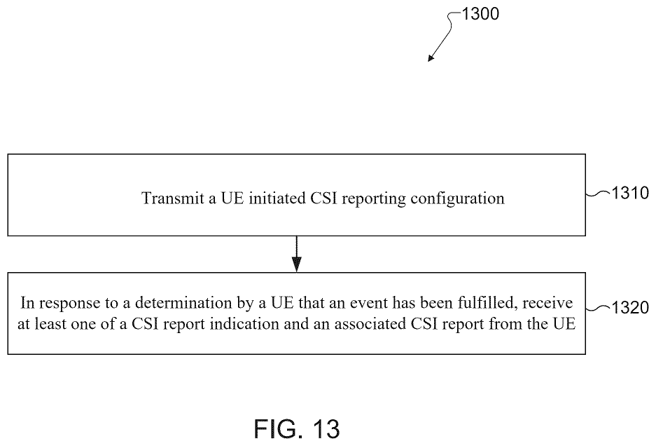

FIG. 13 illustrates another example method for UE-initiated beam reporting trigger states 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for UE-initiated beam reporting trigger states could be used without departing from the scope of this disclosure.

In the example of FIG. 13, the method 1300 begins at step 1310. At step 1310, a BS (such as gNB 102 of FIG. 1) transmits a UE initiated CSI reporting configuration.

At step 1320, in response to a determination by a UE (such as UE 116 of FIG. 1) that an event has been fulfilled, the BS receives at least one of a CSI report indication and an associated CSI report from the UE.

In some embodiments, the UE initiated CSI reporting configuration may be associated to a CSI trigger state dedicatedly for the UE initiated CSI reporting configuration. In embodiments such as these, the UE initiated CSI reporting configuration may include (i) one or more evaluation events and (ii) a list of slot offsets for mode-A UE initiated CSI reporting, and the fulfilled event may be an event from the one or more evaluation events.

In some embodiments, in response to a determination by the UE to transmit the CSI report indication, the BS may receive the CSI report indication in a physical uplink control channel (PUCCH) resource, transmit DCI indicating (i) a value associated with the CSI trigger state associated to the UE initiated CSI reporting configuration and (ii) a slot offset, and receive, from the UE, the associated CSI report according to the UE initiated CSI reporting configuration on a PUSCH dynamic grant using the indicated slot offset.

In some embodiments, the BS may further transmit an aperiodic CSI trigger state subselection MAC CE. In embodiments such as these, the aperiodic CSI trigger state subselection MAC CE may indicate a selected CSI trigger state including the CSI trigger state associated to the UE initiated CSI reporting configuration for mode-A UE-initiated CSI reporting.

In some embodiments, the CSI report may be received from the UE during a FR2 UL gap.

In some embodiments, the UE may be operating in connected mode DRX. In embodiments such as these, the at least one of the CSI report indication and the associated CSI report may be received in an uplink resource scheduled during a DRX active time of the UE.

Although FIG. 13 illustrates one example method for UE-initiated beam reporting trigger states 1300, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving a UE initiated channel state information (CSI) reporting configuration;
performing a CSI measurement based on the UE initiated CSI reporting configuration;
determining, based on the CSI measurement, whether an event has been fulfilled; and
in response to the event being fulfilled, determining whether to transmit at least one of a CSI report indication and an associated CSI report to a network (NW).

2. The method of claim 1, wherein:
the UE initiated CSI reporting configuration is associated to a CSI trigger state dedicatedly for the UE initiated CSI reporting configuration;
the UE initiated CSI reporting configuration includes (i) one or more evaluation events and (ii) a list of slot offsets for mode-A UE initiated CSI reporting; and
the fulfilled event is an event from the one or more evaluation events.

3. The method of claim 2, further comprising, in response to a determination to transmit the CSI report indication:
transmitting the CSI report indication in a physical uplink control channel (PUCCH) resource;
receiving downlink control information (DCI) indicating (i) a value associated with the CSI trigger state associated to the UE initiated CSI reporting configuration and (ii) a slot offset; and
transmitting the associated CSI report according to the UE initiated CSI reporting configuration to the NW on a physical uplink shared channel (PUSCH) dynamic grant using the indicated slot offset.

4. The method of claim 2, further comprising receiving an aperiodic CSI trigger state subselection medium access control (MAC) control element (CE),
wherein the aperiodic CSI trigger state subselection MAC CE indicates a selected CSI trigger state including the CSI trigger state associated to the UE initiated CSI reporting configuration for mode-A UE-initiated CSI reporting.

5. The method of claim 1, wherein in response to a determination to transmit the associated CSI report to the NW, the CSI report is transmitted to the NW during a Frequency Range 2 (FR2) uplink (UL) gap.

6. The method of claim 1, wherein:
cell discontinuous reception (DRX) is activated for a serving cell of the UE; and
determining whether to transmit at least one of the CSI report indication and the associated CSI report to the NW comprises:
determining whether the serving cell is in a cell DRX active period; and
in response to a determination that the serving cell is not in the cell DRX active period:
refraining from transmitting the CSI report indication for mode-A UE initiated CSI reporting; and
refraining from transmitting the CSI report indication and the associated CSI report for mode-B UE initiated CSI reporting.

7. The method of claim 1, wherein:
the UE is operating in connected mode discontinuous reception (DRX); and
determining whether to transmit at least one of the CSI report indication and the associated CSI report to the NW comprises:
determining whether an uplink resource for transmitting the CSI report indication and an uplink resource for transmitting the associated CSI report are scheduled within a DRX active time of the UE; and
in response to a determination that at least one of the uplink resource for transmitting the CSI report indication and the uplink resource for transmitting the associated CSI report are not scheduled within the DRX active time of the UE, refraining from transmitting the CSI report indication and the associated CSI report on the respective uplink resources.

8. A method of operating a base station (BS), the method comprising:
transmitting a user equipment (UE) initiated channel state information (CSI) reporting configuration; and
in response to a determination by a UE that an event has been fulfilled, receiving at least one of a CSI report indication and an associated CSI report from the UE.

9. The method of claim 8, wherein:
the UE initiated CSI reporting configuration is associated to a CSI trigger state dedicatedly for the UE initiated CSI reporting configuration;
the UE initiated CSI reporting configuration includes (i) one or more evaluation events and (ii) a list of slot offsets for mode-A UE initiated CSI reporting; and
the fulfilled event is an event from the one or more evaluation events.

10. The method of claim 9, further comprising, in response to a determination by the UE to transmit the CSI report indication:
receiving the CSI report indication in a physical uplink control channel (PUCCH) resource;
transmitting downlink control information (DCI) indicating (i) a value associated with the CSI trigger state associated to the UE initiated CSI reporting configuration and (ii) a slot offset; and
receiving, from the UE, the associated CSI report according to the UE initiated CSI reporting configuration on a physical uplink shared channel (PUSCH) dynamic grant using the indicated slot offset.

11. The method of claim 9, further comprising, transmitting an aperiodic CSI trigger state subselection medium access control (MAC) control element (CE),
wherein the aperiodic CSI trigger state subselection MAC CE indicates a selected CSI trigger state including the CSI trigger state associated to the UE initiated CSI reporting configuration for mode-A UE-initiated CSI reporting.

12. The method of claim 8, wherein the CSI report is received from the UE during a Frequency Range 2 (FR2) uplink (UL) gap.

13. The method of claim 1, wherein:
the UE is operating in connected mode discontinuous reception (DRX); and
the at least one of the CSI report indication and the associated CSI report are received in an uplink resource scheduled during a DRX active time of the UE.

14. An electronic device comprising:
at least on processor including processing circuitry; and
memory storing instructions, wherein the instructions, when executed by the at least one processor individually or collectively, cause the electronic device to:
receive a user equipment (UE) initiated channel state information (CSI) reporting configuration;
perform a CSI measurement based on the UE initiated CSI reporting configuration;
determine, based on the CSI measurement, whether an event has been fulfilled; and
in response to the event being fulfilled, determine whether to transmit at least one of a CSI report indication and an associated CSI report to a network (NW).

15. The electronic device of claim 14, wherein:
the UE initiated CSI reporting configuration is associated to a CSI trigger state dedicatedly for the UE initiated CSI reporting configuration;
the UE initiated CSI reporting configuration includes (i) one or more evaluation events and (ii) a list of slot offsets for mode-A UE initiated CSI reporting; and
the fulfilled event is an event from the one or more evaluation events.

16. The electronic device of claim 15, wherein the instructions, when executed by the at least one processor individually or collectively, further cause the electronic device to, in response to a determination to transmit the CSI report indication:
transmit the CSI report indication in a physical uplink control channel (PUCCH) resource;
receive downlink control information (DCI) indicating (i) a value associated with the CSI trigger state associated to the UE initiated CSI reporting configuration and (ii) a slot offset; and
transmit the associated CSI report according to the UE initiated CSI reporting configuration to the NW on a physical uplink shared channel (PUSCH) dynamic grant using the indicated slot offset.

17. The electronic device of claim 15, wherein the instructions, when executed by the at least one processor individually or collectively, further cause the electronic device to receive an aperiodic CSI trigger state subselection medium access control (MAC) control element (CE),
wherein the aperiodic CSI trigger state subselection MAC CE indicates a selected CSI trigger state including the CSI trigger state associated to the UE initiated CSI reporting configuration for mode-A UE-initiated CSI reporting.

18. The electronic device of claim 14 wherein in response to a determination to transmit the associated CSI report to the NW, the CSI report is transmitted to the NW during a Frequency Range 2 (FR2) uplink (UL) gap.

19. The electronic device of claim 14 wherein:
cell discontinuous reception (DRX) is activated for a serving cell of the electronic device; and
to determine whether to transmit at least one of the CSI report indication and the associated CSI report to the NW, the instructions, when executed by the at least one processor individually or collectively, further cause the electronic device to:
determine whether the serving cell is in a cell DRX active period; and
in response to a determination that the serving cell is not in the cell DRX active period:
refrain from transmitting the CSI report indication for mode-A UE initiated CSI reporting; and
refrain from transmitting the CSI report indication and the associated CSI report for mode-B UE initiated CSI reporting.

20. The electronic device of claim 14 wherein:
the electronic device is operating in connected mode discontinuous reception (DRX); and
to determine whether to transmit at least one of the CSI report indication and the associated CSI report to the NW, the instructions, when executed by the at least one processor individually or collectively, further cause the electronic device to:
determine whether an uplink resource for transmitting the CSI report indication and an uplink resource for transmitting the associated CSI report are scheduled within a DRX active time of the electronic device; and
in response to a determination that at least one of the uplink resource for transmitting the CSI report indication and the uplink resource for transmitting the associated CSI report are not scheduled within the DRX active time of the electronic device, refrain from transmitting the CSI report indication and the associated CSI report on the respective uplink resources.
